(19) United States
(12) Patent Application Publication
(10) Pub. No.: US 2016/0215537 A1
(43) Pub. Date: Jul. 28, 2016

(54) SELF-ADJUSTABLE LOCK SYSTEM

(71) Applicant: Audrius Macernis, SEAFORD (AU)

(72) Inventor: Audrius Macernis, SEAFORD (AU)

(21) Appl. No.: 14/285,635

(22) Filed: May 23, 2014

(51) Int. Cl. E05C 3/16; E05B 15/02

(52) U.S. Cl. CPC E05C 3/16; E05B 15/0295; E05B 2015/023

(57) ABSTRACT

Disclosed is an adjustable lock system for securing a door to a doorjamb. The lock system comprises a striker assembly mounted to the door, the striker assembly comprising a horizontal striker rod, a pivoting arm, the free end of which is perpendicularly attached with the striker rod, and a striker housing for housing the pivoting arm therewithin, the striker housing comprising a position hole for the striker rod to extend therethrough as the pivoting arm is received therewithin, the position hole to restrict the pivoting movement of the striker rod between a upward striker position to a downward striker position wherein, the various positions between the upward and downward striker positions accommodate various variations of door sag. The receiver assembly comprises a horizontal striker groove for, as the door is closed, retainably receiving the striker rod therewithin.

### BACKGROUND

### Field of the Invention

The present invention relates to various lock systems that are mounted to door and doorjambs, and more particularly to a lock system that is adjustable to offset door sag.

Generally, hinged doors, over time, on account of their constant usage, weight, wear and tear, and sometimes abuse, tend to become sagged. When this happens, among other things, the lock system components that are mounted to the door and the doorjamb become misaligned, thus preventing the door from being shut and locked. One way to fix this problem is to adjust the door to fix the sag, which broadly involves removing the door, replacing the hinges and fasteners on the door and/or on the doorjamb, and securing the door back. The aforesaid process is easier said than done as it is expensive, time-consuming, and requires more than one professional to carry it out. Another option would be to reposition the lock system components, which also is an equally tough proposition requiring either one of components to be removed and repositioned. Further, repeatedly adjusting the door or repositioning the lock system components results in compromising the aesthetic look of the door, or even worse, compromising the integrity of the door and doorjamb, which in turn may lead to the entire door and the door frame having to be replaced. There is a need in the art for a simpler alternative to the aforementioned door sag solutions.

### SUMMARY

The present invention comprises an adjustable lock system comprising a striker assembly mounted to the door and a receiver assembly matchingly mounted to the doorjamb. The striker assembly comprises a self-adjusting horizontal striker rod, the axis of which is parallel to the door. The receiver assembly on the other hand comprises a striker groove for receiving the striker rod therewithin. The receiver assembly further comprises a pair of retainers for retaining the striker rod once received within the striker groove. The striker rod, while remaining horizontal at all times, is adapted to be movable between a downward striker position to an upward striker position in accordance with the degree of door sag. For example, when door sag (that can be accommodated by the lock system) is observed, the striker rod upon the impact thereof with the striker groove (when closing the door) self-adjusts itself to a suitable position between the downward and upward striker positions. Notably, the striker rod also self-adjusts itself for possible upward positioning of the door or downward positioning of the striker groove.

Other objects and advantages of the embodiments herein will become readily apparent from the following detailed description taken in conjunction with the accompanying drawings.

### BRIEF DESCRIPTION OF THE DRAWINGS

FIG. 1, according to an embodiment of the present invention, is an illustration of a perspective view of the lock system.

FIG. 2, according to an embodiment of the present invention, is an illustration of a perspective view of the lock system secured to a door and a doorjamb.

FIG. 3, according to an embodiment of the present invention, is an illustration of a perspective view of the striker assembly.

FIG. 4, according to an embodiment of the present invention, is an illustration of the front view of the striker assembly.

FIG. 5, according to an embodiment of the present invention, is an illustration of a top sectional view of the striker assembly.

FIG. 6, according to an embodiment of the present invention, is an illustration of a partially cutaway perspective view of the striker assembly.

FIG. 7, according to an embodiment of the present invention, is an illustration of a perspective view of the pivoting arm and the striker rod.

FIG. 8, according to an embodiment of the present invention, is an illustration of a side view of the pivoting arm and the striker rod.

FIG. 9, according to an embodiment of the present invention, is an illustration of a side view of the striker assembly with the striker rod at the downward striker position.

FIG. 10, according to an embodiment of the present invention, is an illustration of a side view of the striker assembly with the striker rod at the upward striker position.

FIG. 11, according to an embodiment of the present invention, is an illustration of a perspective view of the receiver assembly.

FIG. 12, according to an embodiment of the present invention, is an illustration of the receiver assembly with the retainers in the blocked position.

FIG. 13, according to an embodiment of the present invention, is an illustration of the receiver assembly with the retainers in the unblocked position.

FIG. 14, according to an embodiment of the present invention, is an illustration of a side view of the receiver assembly without the receiver body.

FIG. 15, according to an embodiment of the present invention, is an illustration of the rear view of the receiver assembly.

FIG. 16, according to an embodiment of the present invention, is an illustration of the retainer.

### REFERENCE NUMERALS

10—Adjustable Lock System
12—Door
14—Doorjamb
16—Striker Assembly
18—Receiver Assembly
20—Striker Rod
22—Pivoting Arm
24—Striker Housing
26—Lip Member
28—Pivot Pin
30—Position Hole
32—Striker Panel
34—Fastener Hole
36—Receiver Body
38—Striker Groove
40—Top Portion of the Receiver Body
42—Bottom Portion of the Receiver Body
44—Retainer
46—Pull Knob
48—Activator
50—Return Spring
52—Retainer Pin
54—Pin Locator
56—Pin Spacer
58—Pin Hole
60—Centre of Gravity
62—Curved Leading Surface

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

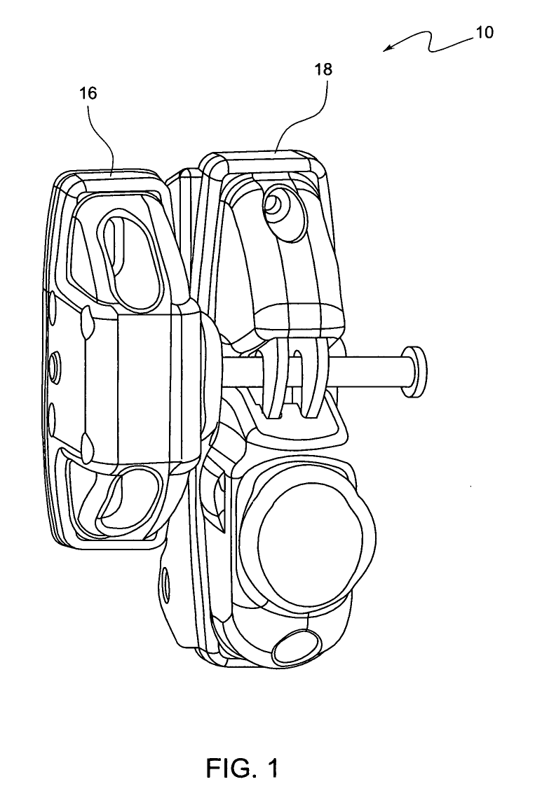

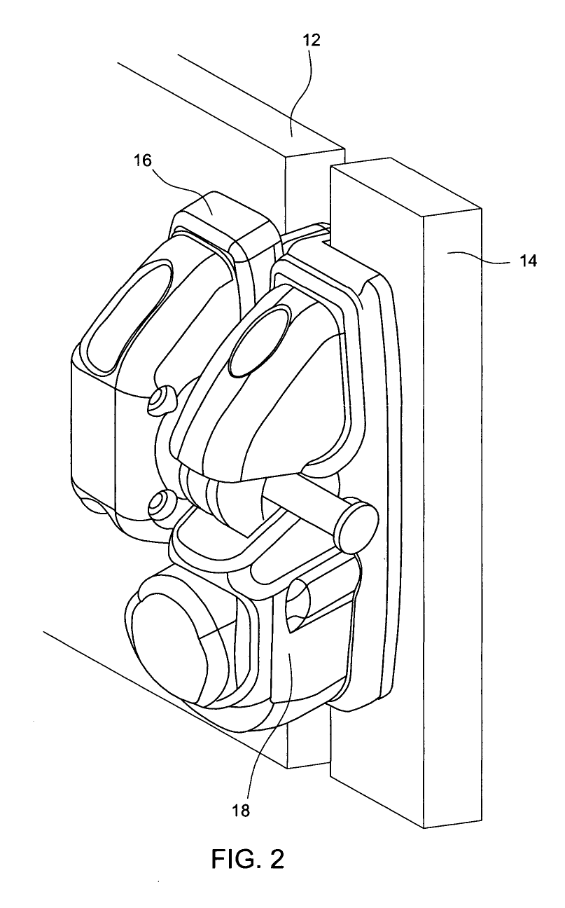

Referring to FIGS. 1 and 2, the present invention comprises an adjustable lock system 10 for securing a door 12 to a doorjamb 14 even in the event of the door 12 being sagged. The lock system 10 comprises a striker assembly 16 and a receiver assembly 18 wherein, the striker and the receiver assemblies 16 and 18 are adapted to be secured to the door 12 and the doorjamb 14 respectively. More particularly, each of the striker and receiver assemblies 16 and 18 is secured to the vertical front side of the door 12 and the doorjamb 14 respectively by means of an L-shaped mounting bracket that is preferably integrally formed therewith and commonplace fasteners, such as screws, nails, etc.

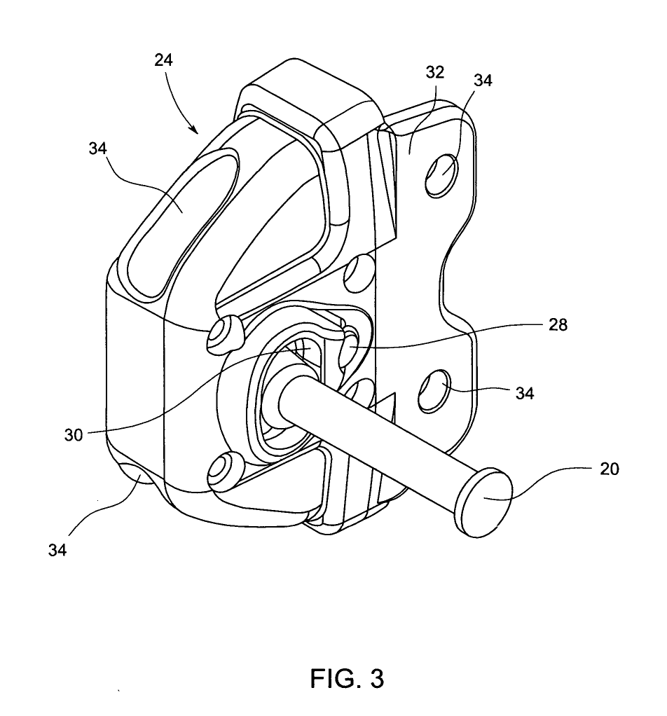

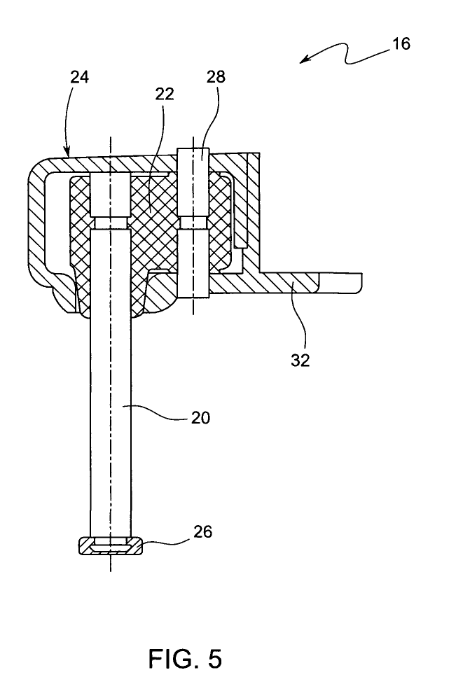

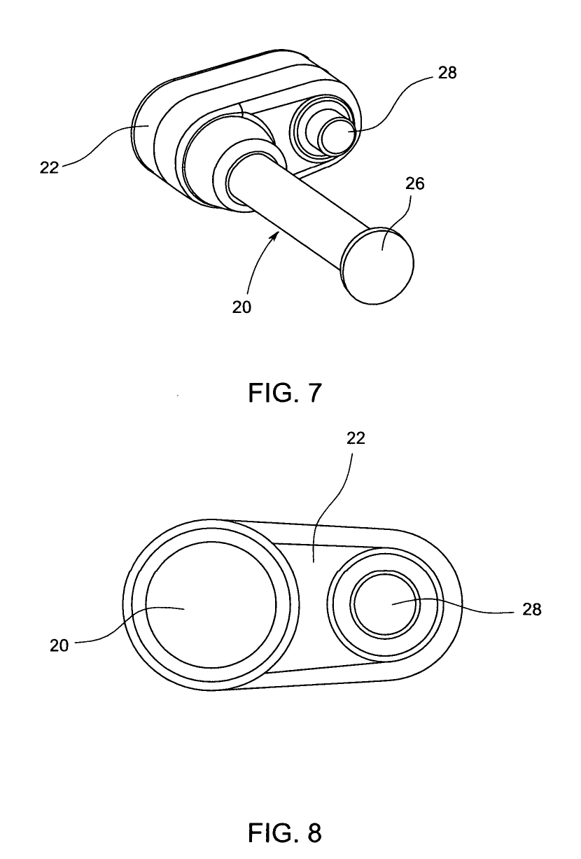

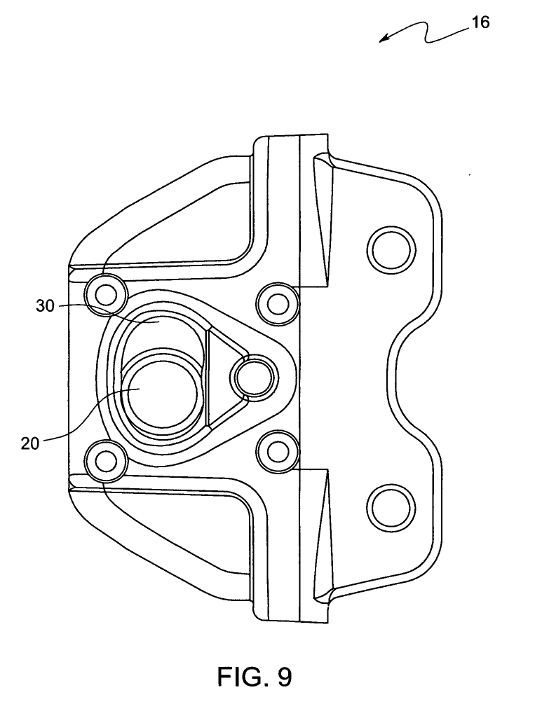

Referring to FIGS. 3 through 8, the striker assembly 16 comprises a striker rod 20, a pivoting arm 22, and a striker housing 24. The striker rod 20 comprises an elongate, cylindrical rod comprising a proximal and a distal end. The distal end portion of the striker rod 20 extends through the free end of the pivoting arm 22 (the other end of which is pivoted) such that, the pivoting arm 22 and the striker rod 20 are perpendicular to one another. More particularly, the distal end portion of the striker rod 20, as can be seen more clearly in FIGS. 5 and 7, extends through the pivoting arm 22 such that, the distal end is disposed on one side of the pivoting arm 22, while the proximal end is disposed on the other side. The proximal end of the striker rod 20 terminates in a circular lip member 26, which is perpendicular to the longitudinal axis of the striker rod 20. Barring the lip member 26, the striker rod 20 is of uniform circular cross-section. The striker rod 20 is preferably made of stainless steel.

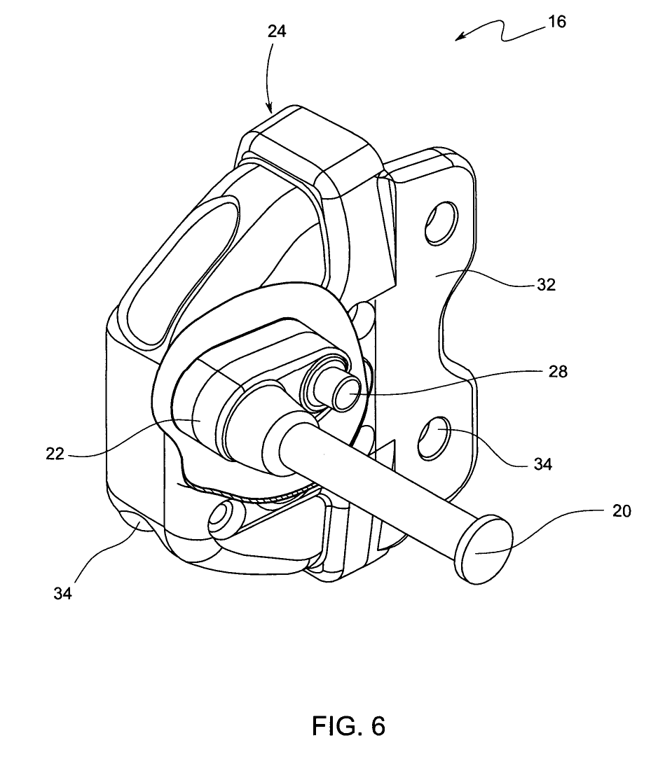

Referring to FIGS. 6 through 8, the pivoting arm 22 resembles a sector-shaped member of suitable thickness comprising a fixed converging end at which, the pivoting arm 22 is pivoted about a pivot pin 28, and a free diverging end wherefrom, as mentioned earlier, the striker rod 20 extends via a striker hole. Notably, the longitudinal axis of the pivot pin 28 is parallel to that of the striker rod 20. The pivoting arm 22 is tightly pivoted The pivoting arm 22 is preferably made of a plastic material.

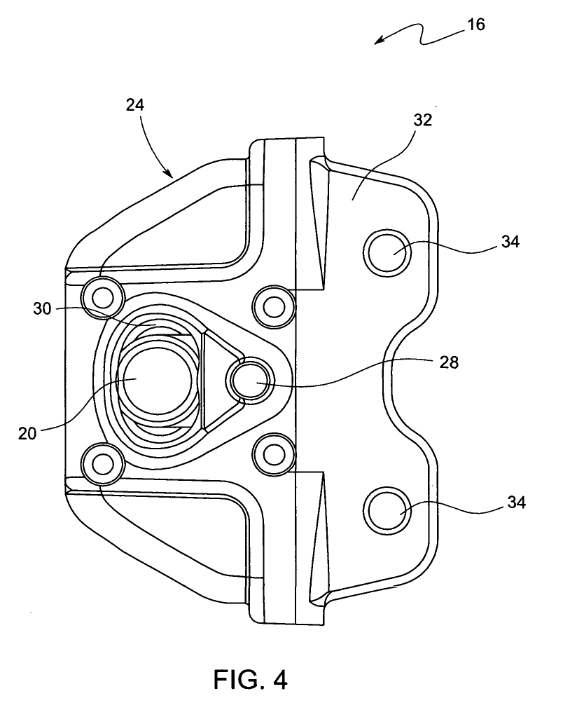

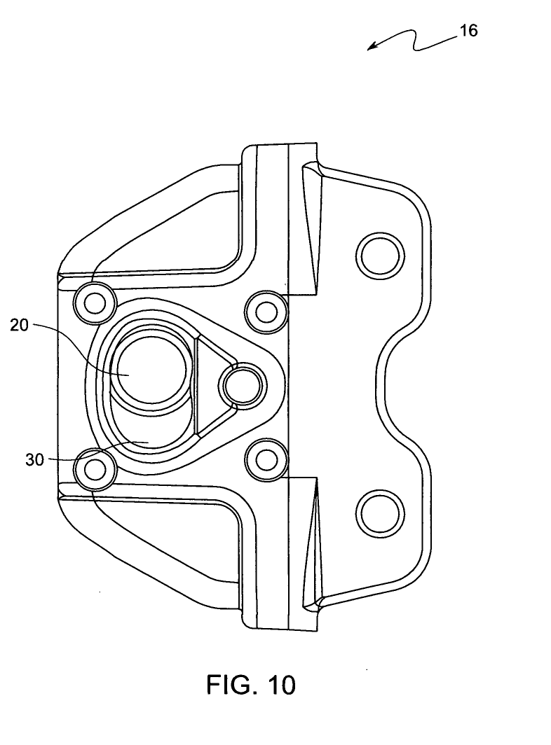

Referring to FIGS. 3 and 4, the striker housing 24 comprises an enclosure for housing the pivoting arm 22 and a distal portion of the striker rod (including the distal end) therewithin. The striker housing 24 comprises a pair of opposite pivot holes for fixedly supporting the opposite ends of the pivot pin 28 whereon, as mentioned earlier, the pivoting arm 22 is supported. The striker housing 24 further comprises a nearly-oblong, angular position hole disposed on the side thereof for enabling the striker rod 20 to extend therethrough as the pivoting arm 22 is received within the striker housing 24. The striker rod 20 within the position hole 30 is movable between a downward striker position (FIG. 9) and an upward striker position (FIG. 10) wherein, the striker rod 20 is adapted to self-adjust between the downward and upward striker positions proportionate to the door sag. Notably, the various striker rod positions between the downward and upward striker positions are employed to accommodate the various degrees of door sag or the various degrees of misalignment between the striker and receiver assemblies 16 and 18.

Still referring to FIGS. 3 and 4, the rear surface of striker housing 24 is flat and includes a flat striker panel 32 that is perpendicular thereto wherein, the flat surface abuts the front of the door 12, while the striker panel 32 abuts the side of the door 12 as the striker housing 24 is mounted to the door 12. Fastener holes 34 are provided on striker panel 32 and on rear surface (accessible from the front) for fastening the striker housing 24 to the door 12 by means of suitable fasteners such as, screws or the like. The striker housing 24 is preferably made of a strong plastic material.

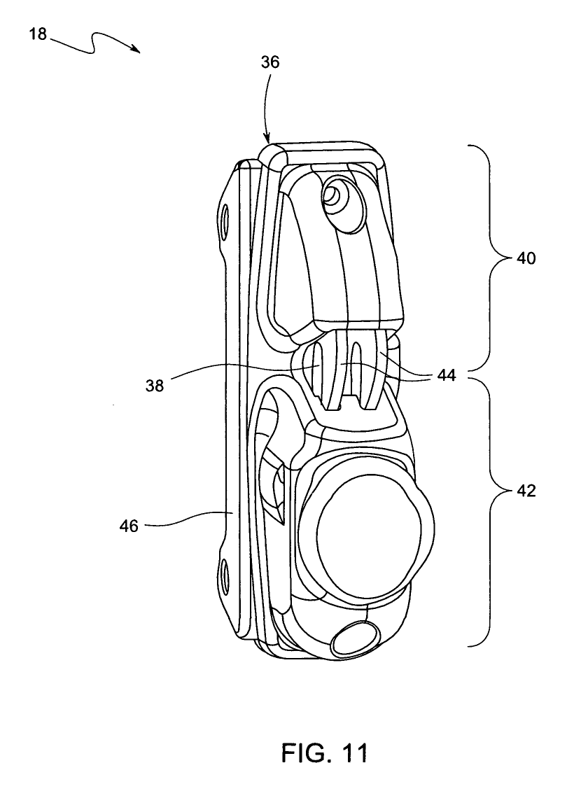

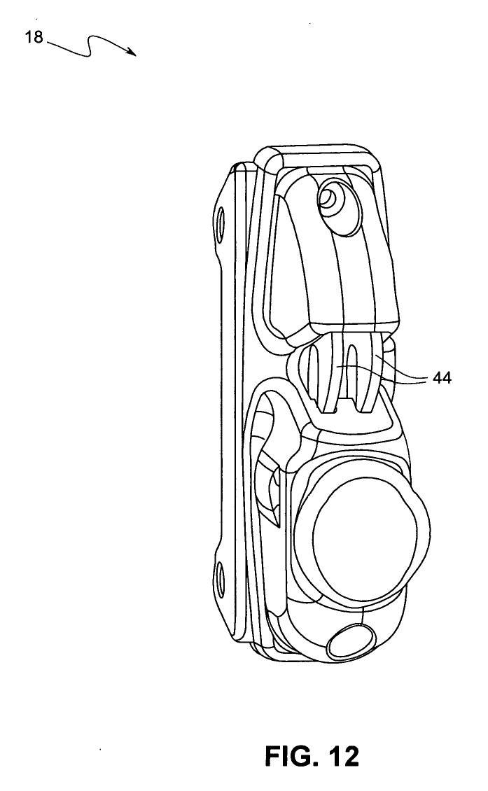

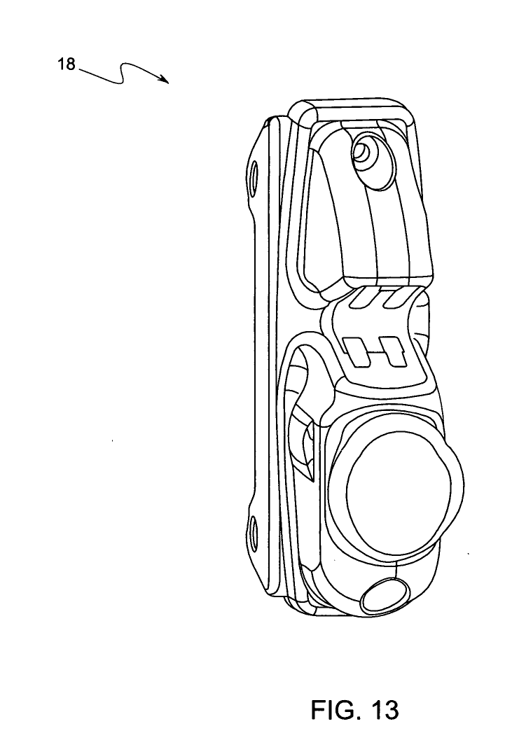

Referring to FIGS. 1, 2, and 11, the receiver assembly 18 comprises a receiver body 36 comprising a horizontal, thorough, striker groove 38 formed therein for receiving the striker rod 20 therewithin so as to shut the door 12. For ease of understanding, with the striker groove 38 as a reference, the receiver body is divided into top and bottom portions 40 and 42, each comprising a front oblique surface wherein, the front surfaces are angularly divergent with respect to one another. In other words, the striker groove 38 is convergent from a pair of upward and downward oblique surfaces. The receiver assembly 18 further comprises, at least one, and preferably two spaced-apart, retractable, hook or claw-shaped retainers 44 for retaining the striker rod 20 within the striker groove 38. The retainers 44, which are functionally independent with respect to one another, are movable between a default downward blocking position (FIG. 12) to an upward unblocking position (FIG. 13) wherein, in the blocking position (FIG. 12), the retainers 44 extend between the front oblique surfaces of the top and bottom portions 40 and 42 of the receiver body 36 preventing any access into and out of the striker groove 38, and wherein, in the unblocking position (FIG. 13), the retainers 44 are retracted into the top portion 40 of the receiver body 36 allowing access into and out of the striker groove 38. Further, a pull knob 46 is provided, preferably on the bottom portion 42 of the receiver body 18, which when depressed, retracts the retainers 44 into the top portion 40 of the retainer body 18 so as to enable a user to release the striker rod 20 from the striker groove 38 in order to open the door 12.

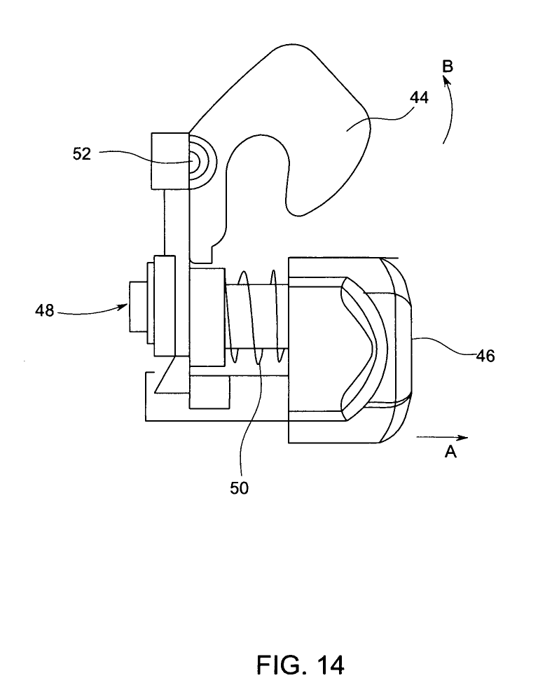

Referring to FIG. 14, the retainer 2 is pivotally mounted on a retainer pin (not visible), allowing the latching element to rotate between the blocking position (FIG. 12) and the unblocking position (FIG. 13). The pull knob 46 is connected to an activator 48, such that when pull knob 46 is pulled in the direction A, the activator 48, which is displaced in the same direction as the pull knob 46, causes the retainer to rotate in the direction B towards the unblocking position. Preferably a biasing means in the form of a return spring 50 is provided to bias the pull knob 46 and activator 48 to the normal positions thereof, thereby allowing the retainer 46 to return to the blocking position (FIG. 12) upon release of the pull knob 46.

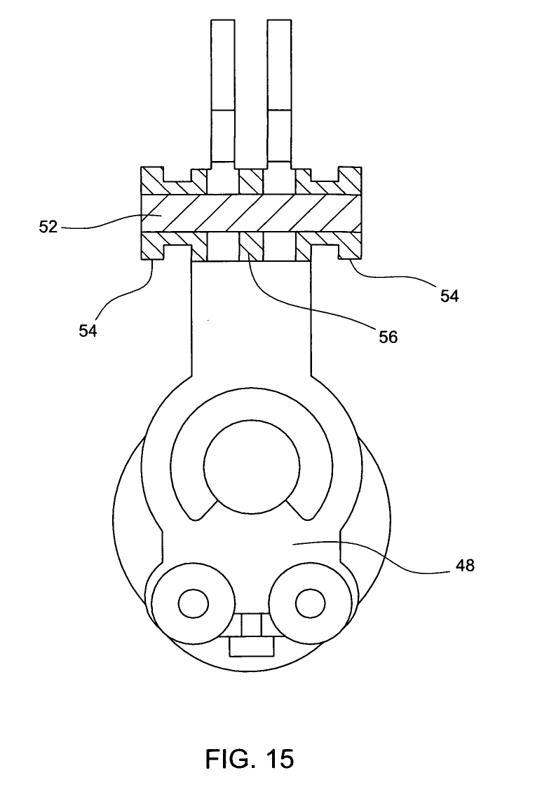

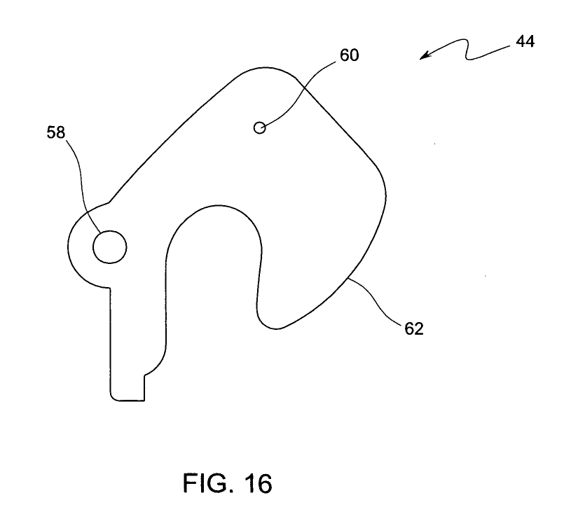

Referring to FIGS. 15 and 16, the retainer pin 52 is positioned in the housing by a pair of pin locators 54, and the retainers are spaced apart on the pin by means of a pin spacer 56. Now referring to FIG. 16, the retainer 44 is provided with a pin hole 58 for receiving the retainer pin 52. Preferably the retainer 44 is designed to have a centre of gravity 60 positioned laterally from the pin hole 58, such that, the retainer falls to the blocking position as shown in FIG. 12 under the force of gravity. It will be appreciated that other arrangements achieving this result are also possible, for example, such as by urging the retainer 44 towards the blocking position (FIG. 12) by use of a biasing means, such as a spring, and such arrangements are to be understood as being included in the invention in its broadest form. Further, each retainer 44, owing to the claw-shape thereof, comprises a curved leading surface 62, which, when comes into contact with the curved surface of the striker rod 20 with sufficient impact (generated by the shutting of the door), deflects into the unblocking position (FIG. 13), followed by, admitting the striker rod 20 within the striker groove 38. As the retainers 44 are biased towards the blocking position (FIG. 12), once the striker rod 20 is within the striker groove 38, the retainers 44 move back into the blocking position (FIG. 12), thus blocking the striker rod 20 within the striker groove 38 so as to ultimately secure the door 12 to the doorjamb 14. The lock system 10 is self-adjusting because, in case of a door sag, when the door 12 is closed, the striker rod 20, instead of coming into contact with the retainers 44, comes into contact with one of the oblique surfaces causing the pivoting arm 22 to adjust its pivoting angle with respect to the degree of door sag. The lock system 10 not only self-adjusts in the case of the door sag but also in the case of any (upward or downward) deviation in the alignment between the striker 16 and the receiver assembly 18.

Referring to FIGS. 1, 2, and 11, similar to the striker housing 24, the rear surface of receiver body 36 is flat and includes a flat receiver panel 46 that is perpendicular thereto wherein, the flat rear surface of the receiver body 36 abuts the front of the doorjamb 14, while the receiver panel 46 abuts the side of the doorjamb 14 as the receiver body 36 is mounted to the doorjamb 14. Fastener holes 34 are provided on the receiver panel 46 and on rear surface (accessible from the front) of the receiver body 36 for fastening the receiver body 36 to the doorjamb 14 by means of suitable fasteners such as, screws or the like. The receiver body 36 is preferably made of a strong plastic material.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. For example, the adjustable lock system may be installed on gates instead on doors. However, all such modifications are deemed to be within the scope of the claims.

What is claimed is:

1. A lock system for securing a hinged closure member to a jamb, the lock system being self-adjustable in order to facilitate the securing of the closure member to the jamb in the event of closure member being sagged, the lock system comprising a striker assembly secured to the closure member, the striker assembly comprising:
(a) a horizontal, elongate striker rod parallel to the closure member, the striker rod extending beyond an edge of the closure member;
(b) a pivoting arm pivoting about a horizontal axis parallel to the longitudinal axis of the striker rod, the free end of the pivoting arm attached with the striker rod such that, the striker rod and the pivoting arm are perpendicular to one another; and
(c) a striker housing for housing the pivoting arm therewithin, the striker housing comprising a side position hole for the striker rod to extend therethrough as the pivoting arm is received therewithin, the position hole restricting the pivoting movement of the striker rod between a upward striker position and a downward striker position;
wherein, as the closure member is closed, the striker rod is received within a striker groove located on the jamb and thereafter retained therewithin so as to secure the closure member to the jamb, the striker groove being convergent from a pair of upward and downward oblique surfaces, which, in the event of the closure member being sagged and as the sagged closure member is closed, causes the striker rod to collide with one of the oblique surfaces resulting in the striker rod being self-adjusted to any suitable position between the upward and downward striker positions in order to be received within the striker groove.

2. The lock system of claim 1 wherein, the striker groove is disposed on a receiver assembly fitted to the jamb.

3. The lock system of claim 2 wherein, the receiver assembly comprises at least one retainer for retaining the striker rod within the striker groove.

4. The lock system of claim 3 wherein, the retainer is movable between a downward blocking position and an upward unblocking position wherein, access to the striker groove is blocked by the retainer in the blocked position, and wherein, access to the striker groove is allowed by the retainer in and the unblocked position, the retainer biased towards the blocking position.

5. The lock system of claim 4 wherein, the retainer comprises a curved leading surface wherein, when the striker comes into contact therewith with ample impact that is provided during the closure of the closure member, the retainer is deflected to the unblocking position causing the striker to enter the striker groove.

6. The lock system of claim 3 wherein, each of the at least one retainer comprises a claw-shaped member.

7. The lock system of claim 3 wherein, the at least one retainer comprises two retainers.

8. The lock system of claim 1 wherein, the striker rod is of circular cross-section.

9. The lock system of claim 1 wherein, the closure member comprises a door.

10. The lock system of claim 1 wherein, the jamb comprises a doorjamb.

11. A lock system for securing a hinged door to a doorjamb, the lock system being self-adjustable in order to facilitate the securing of the door to the doorjamb in the event of door being sagged, the lock system comprising a striker assembly secured to the door, the striker assembly comprising:
(a) a horizontal, elongate striker rod parallel to the door, the striker rod extending beyond a vertical side edge of the door, the striker rod being of uniform circular cross-section;
(b) a pivoting arm pivoting about a horizontal axis parallel to the longitudinal axis of the striker rod, the free end of the pivoting arm attached with the striker rod such that, the striker rod and the pivoting arm are perpendicular to one another; and
(c) a striker housing for housing the pivoting arm therewithin, the striker housing comprising a side position hole for the striker rod to extend therethrough as the pivoting arm is received therewithin, the position hole restricting the pivoting movement of the striker rod between a upward striker position and a downward striker position.

12. A self-adjustable lock system for securing a hinged closure member to a jamb, the lock system being adjustable to facilitate the securing of the closure member to the jamb in the event of closure member being sagged, the lock system comprising:
(a) a striker assembly secured to the closure member, comprising:
(i) a horizontal, elongate striker rod parallel to the closure member;
(ii) a pivoting arm pivoting about a horizontal axis parallel to the longitudinal axis of the striker rod, the free end of the pivoting arm attached with the striker rod such that, the striker rod and the pivoting arm are perpendicular to one another; and
(iii) a striker housing for housing the pivoting arm therewithin, the striker housing comprising a side position hole for the striker rod to extend therethrough as the pivoting arm is received therewithin, the position hole to restrict the pivoting movement of the striker rod between a upward striker position to a downward striker position wherein, the striker rod being utilized at the downward striker position indicates that the closure member is devoid of any sag, and wherein, the striker rod being utilized at the upward striker position indicates that the closure member has the maximum sag that can be accommodated by the lock system; and
(b) a receiver assembly secured to the jamb, comprising:
(i) a thorough, horizontal, striker groove for receiving the striker rod therewithin as the closure member is closed; and
(ii) at least one one retainer for, upon receiving the striker rod within the striker groove, retaining the striker rod within the striker groove.

13. The lock system of claim 12 wherein, the retainer is movable between a downward blocking position and an upward unblocking position wherein, access to the striker groove is blocked by the retainer in the blocked position, and wherein, access to the striker groove is allowed by the retainer in and the unblocked position, the retainer biased towards the blocking position.

14. The lock system of claim 13 wherein, the retainer comprises a curved leading surface wherein, when the striker comes into contact therewith with ample impact that is provided during the closure of the closure member, the retainer is deflected to the unblocking position causing the striker to enter the striker groove.

15. The lock system of claim 12 wherein, each of the at least one retainer comprises a claw-shaped member.

16. The lock system of claim 12 wherein, the at least one retainer comprises two retainers.

17. The lock system of claim 12 wherein, the striker rod is of circular cross-section.

18. The lock system of claim 12 wherein, the closure member comprises a door.

19. The lock system of claim 12 wherein, the jamb comprises a doorjamb.

20. The lock system of claim 12 wherein, the striker groove being convergent from a pair of upward and downward oblique surfaces, which, in the event of the closure member being sagged and as the sagged closure member is closed, causes the striker rod to collide with one of the oblique surfaces resulting in the striker rod being self-adjusted to any suitable position between the upward and downward striker positions in order to be received within the striker groove.
